(19) United States
(12) Patent Application Publication
(10) Pub. No.: US 2013/0274490 A1
(43) Pub. Date: Oct. 17, 2013

(54) Extraction of Lipids From Algae

(71) Applicants: Jeffrey G. Hippler, Alameda, CA (US); Megan Hippler, Karratha (AU); Nathaniel Nicks, San Francisco, CA (US)

(72) Inventors: Jeffrey G. Hippler, Alameda, CA (US); Megan Hippler, Karratha (AU); Nathaniel Nicks, San Francisco, CA (US)

(21) Appl. No.: 13/444,827

(22) Filed: Apr. 11, 2012

(51) Int. Cl. C11B 1/10

(52) U.S. Cl. 554/19; 554/8; 554/21; 554/20

(57) ABSTRACT

Various embodiments of the present invention are directed to processes and methods for extracting lipids from a variety of algae species. An exemplary method comprises treating the algae with a mixture of at least one nonpolar solvent and at least one polar solvent heated to temperature at which the nonpolar solvent and the polar solvent are miscible.

### FIELD OF THE INVENTION

The present invention is directed to systems and methods for extracting lipids from algae.

### SUMMARY OF THE INVENTION

Various embodiments of the present invention include systems and methods for extracting lipids from a variety of algae species. An exemplary method comprises treating the algae with a mixture of at least one nonpolar solvent and at least one polar solvent heated to a temperature at which the nonpolar solvent and the polar solvent are miscible. The nonpolar solvent may have a dielectric constant less than or equal to about 5, and the polar solvent may have a dielectric constant greater than or equal to about 25. The weight percent of the nonpolar solvent in the mixture may range from about 99.9 percent to about 70 percent, and the weight percent of the polar solvent may range from about 0.1 percent to about 30 percent.

### BRIEF DESCRIPTION OF THE DRAWINGS

FIG. 1 is a general flow chart of an exemplary method for producing fatty esters according to various embodiments of the present invention.

FIG. 2 is a flow chart of a method for converting lipids comprising fatty acids into fatty esters according to various embodiments of the present invention.

FIG. 3 is a flow chart of a method for extracting lipids from algae according to various embodiments of the present invention.

### DETAILED DESCRIPTION

Various embodiments of the present invention include systems and methods for extracting lipids from a variety of algae species. An exemplary method comprises treating the algae with a mixture of at least one nonpolar solvent and at least one polar solvent. The solvent mixture may be heated to a temperature less than the boiling point of either the non-polar or polar solvent, and typically to a temperature at which the nonpolar solvent and the polar solvent are miscible. The nonpolar solvent may have a dielectric constant less than or equal to about 5, and the polar solvent may have a dielectric constant greater than or equal to about 25. The weight percent of the nonpolar solvent in the mixture may range from about 99.9 percent to about 70 percent, and the weight percent of the polar solvent may range from about 0.1 percent to about 30 percent.

Lipids are a broad class of chemical compounds that may be defined as “fatty acids and their derivatives, and the substances related biosynthetically or functionally to these compounds” [W. W. Christie, Gas Chromatography and Lipids: A Practical Guide (1989), p. 5]. Most lipids are soluble in organic solvents, but many are insoluble in water; however, given the diverse nature of lipids, some compounds regarded as lipids may also be soluble in water. Organic solvents in which lipids are soluble are generally non-polar solvents and may include pentane, cyclopentane, hexane, cyclohexane, benzene, toluene, 1,4-dioxane, chloroform, diethyl ether, methylene chloride, ethyl acetate, d-limonene, heptane, naphtha, and xylene, among others. Higher melting point lipids are typically solids at room temperature and are broadly classified as fats or waxes. Lipids with lower melting points are typical liquids at room temperature and are broadly classified as oils.

Comprehensive classification of lipids is difficult because of their diverse nature. One classification system for biological lipids is based on the biochemical subunits from which the lipids originate. This system provides for various general categories of biological lipids, including fatty acyls, glycerolipids, glycerophospholipids, sphingolipids, saccharolipids, sterol lipids, and glycolipids. Fatty acyls (or fatty acids and their conjugates and derivatives) are straight-chain carbon compounds that may be naturally synthesized via condensation of malonyl coenzyme A units by a fatty acid synthase complex. Fatty acyls typically have a carbon chain comprised of 4 to 24 carbon atoms, and often terminate with a carboxyl group (—COOH). Lipids containing fatty acyls can be hydrolyzed into alkali fatty acid salts using basic hydrolysis, a process known as saponification. Fatty acyls may be saturated or unsaturated, and may also include functional groups containing oxygen, nitrogen, sulfur, and halogens. Fatty acyls found in plant tissues commonly have a carbon chain comprised of 14, 16, 18, 20, or 24 carbon atoms.

Common fatty acyls of plant and animal origin can be divided into three broad categories of saturated fatty acids, monoenoic fatty acids, and polyunsaturated fatty acids. Saturated fatty acids are characterized as having 2 or more carbon atoms in the carbon chain with no double bonds between any of the carbon atoms. Exemplary saturated fatty acids include ethanoic acid, butanoic acid, hexanoic acid, octanoic acid, decanoic acid, dodecanoic acid, tetradecanoic acid, hexadecanoic acid, octadecanoic acid, eicosanoic acid, docosanoic acid, and tetracosanoic acid. Monoenoic fatty acids are characterized as having a single carbon-carbon double bond in the carbon chain. The double bond is typically a cis-configuration, although some trans-configuration compounds are known. Exemplary monoenoic fatty acids include cis-9-hexadecenoic acid, cis-6-octadecenoic acid, cis-9-octadecenoic acid, cis-11-octadecenoic acid, cis-13-docosenoic acid, and cis-15-tetracosenoic acid. Polyunsaturated fatty acids are characterized as having two or more carbon-carbon double bonds in the carbon chain. Exemplary polyunsaturated fatty acids include 9,12-octadecadienoic acid, 6,9,12-octadecatrienoic acid, 9,12,15-octadecatrienoic acid, 5,8,11,14-eicosatetraenoic acid, 5,8,11,14,17-eicosapentaenoic acid, and 4,7,10,13,16,19-docosahexanoic acid.

Glycerolipids may be formed by joining fatty acids to glycerol by ester bonds. The majority of glycerolipids are formed by mono-, di-, or tri-substitution of fatty acids on the glycerol molecule. The most common naturally occurring glycerolipids are of the tri-substituted variety, known as triacylglycerols or triglycerides. Exemplary glycerolipids include monoradylglycerols, monoacylglycerols, monoalkylglycerols, mono-(1Z-alkenyl)-glycerols, diradylglycerols, diacylglycerols, 1-alkyl,2-acylglycerols, 1-acyl,2-alkylglycerols, dialkylglycerols, 1Z-alkenylacylglycerols, di-glycerol tetraethers, di-glycerol tetraether glycans, triradylglycerols, triacylglycerols, alkyldiacylglycerols, dialkylmonoacylglycerols, 1Z-alkenyldiacylglycerols, estolides, glycosylmonoradylglycerols, glycosylmonoacylglycerols, glycosylmonoalkylglycerols, glycosyldiradylglycerols, glycosyldiacylglycerols, glycosylalkylacylglycerols, and glycosyldialkylglycerols.

Glycerophospholipids (or simply phospholipids) may be characterized by fatty acids linked through an ester oxygen to the first and second carbon atoms of the glycerol molecule, with a phosphate functional group ester-linked to the third carbon atom to the glycerol molecule. Other functional groups may also be linked to the phosphate functional group. In plant and animal cells, glycerophospholipids may serve as structural components of the cell membrane. Exemplary glycerophospholipids include phosphatidyl choline (lecithin), phosphatidyl ethanolamine (cephalin), phosphatidyl inositol, phosphatidylserine, bisphosphatidylglycerol (cardiolipin), glycerophosphocholines, diacylglycerophosphocholines, 1-alkyl,2-acylglycerophosphocholines, 1-acyl,2-alkylglycerophosphocholines, 1Z-alkenyl,2-acylglycerophosphocholines, dialkylglycerophosphocholines, monoacylglycerophosphocholines, monoalkylglycerophosphocholines, 1Z-alkenylglycerophosphocholines, glycerophosphoethanolamines, diacylglycerophosphoethanolamines, 1-alkyl,2-acylglycerophosphoethanolamines, 1-acyl,2-alkylglycerophosphoethanolamines, 1Z-alkenyl,2-acylglycerophosphoethanolamines, dialkylglycerophosphoethanolamines, monoacylglycerophosphoethanolamines, monoalkylglycerophosphoethanolamines, 1Z-alkenylglycerophosphoethanolamines, glycerophosphoserines, diacylglycerophosphoserines, 1-alkyl,2-acylglycerophosphoserines, 1Z-alkenyl,2-acylglycerophosphoserines, dialkylglycerophosphoserines, monoacylglycerophosphoserines, monoalkylglycerophosphoserines, 1Z-alkenylglycerophosphoserines, glycerophosphoglycerols, diacylglycerophosphoglycerols, 1-alkyl,2-acylglycerophosphoglycerols, 1-acyl,2-alkylglycerophosphoglycerols, 1Z-alkenyl,2-acylglycerophosphoglycerols, dialkylglycerophosphoglycerols, monoacylglycerophosphoglycerols, monoalkylglycerophosphoglycerols, 1Z-alkenylglycerophosphoglycerols, diacylglycerophosphodiradylglycerols, diacylglycerophosphomonoradylglycerols, monoacylglycerophosphomonoradylglycerols, glycerophosphoglycerophosphates, diacylglycerophosphoglycerophosphates, 1-alkyl,2-acylglycerophosphoglycerophosphates, 1Z-alkenyl,2-acylglycerophosphoglycerophosphates, dialkylglycerophosphoglycerophosphates, monoacylglycerophosphoglycerophosphates, monoalkylglycerophosphoglycerophosphates, 1Z-alkenylglycerophosphoglycerophosphates, glycerophosphoinositols, diacylglycerophosphoinositols, 1-alkyl,2-acylglycerophosphoinositols, 1Z-alkenyl,2-acylglycerophosphoinositols, dialkylglycerophosphoinositols, monoacylglycerophosphoinositols, onoalkylglycerophosphoinositols, 1Z-alkenylglycerophosphoinositols, glycerophosphoinositol monophosphates, diacylglycerophosphoinositol monophosphates, 1-alkyl,2-acylglycerophosphoinositol monophosphates, 1Z-alkenyl,2-acylglycerophosphoinositol monophosphates, dialkylglycerophosphoinositol monophosphates, monoacylglycerophosphoinositol monophosphates, monoalkylglycerophosphoinositol monophosphates, 1Z-alkenylglycerophosphoinositol monophosphates, glycerophosphoinositol bisphosphates, diacylglycerophosphoinositol bisphosphates, 1-alkyl,2-acylglycerophosphoinositol bisphosphates, 1Z-alkenyl,2-acylglycerophosphoinositol bisphosphates, monoacylglycerophosphoinositol bisphosphates, onoalkylglycerophosphoinositol bisphosphates, 1Z-alkenylglycerophosphoinositol bisphosphates, glycerophosphoinositol trisphosphates, diacylglycerophosphoinositol trisphosphates, 1-alkyl,2-acylglycerophosphoinositol trisphosphates, 1Z-alkenyl,2-acylglycerophosphoinositol trisphosphates, monoacylglycerophosphoinositol trisphosphates, monoalkylglycerophosphoinositol trisphosphates, 1Z-alkenylglycerophosphoinositol trisphosphates, glycerophosphates, diacylglycerophosphates, 1-alkyl,2-acylglycerophosphates, 1Z-alkenyl,2-acylglycerophosphates, dialkylglycerophosphates, monoacylglycerophosphates, monoalkylglycerophosphates, 1Z-alkenylglycerophosphates, glyceropyrophosphates, diacylglyceropyrophosphates, monoacylglyceropyrophosphates, glycerophosphoglycerophosphoglycerols, diacylglycerophosphoglycerophosphodiradylglycerols, diacylglycerophosphoglycerophosphomonoradylglycerols, 1-alkyl,2-acylglycerophosphoglycerophosphodiradylglycerols, 1-alkyl,2-acylglycerophosphoglycerophosphomonoradylglycerols, 1Z-alkenyl,2-acylglycerophosphoglycerophosphodiradylglycerols, 1Z-alkenyl,2-acylglycerophosphoglycerophosphomonoradylglycerols, dialkylglycerophosphoglycerophosphodiradylglycerols, dialkylglycerophosphoglycerophosphomonoradylglycerols, monoacylglycerophosphoglycerophosphomonoradylglycerols, monoalkylglycerophosphoglycerophosphodiradylglycerols, monoalkylglycerophosphoglycerophosphomonoradylglycerols, 1Z-alkenylglycerophosphoglycerophosphodiradylglycerols, 1Z-alkenylglycerophosphoglycerophosphomonoradylglycerols, CDP-glycerols, CDP-diacylglycerols, CDP-1-alkyl,2-acylglycerols, CDP-1Z-alkenyl,2-acylglycerols, CDP-dialkylglycerols, CDP-monoacylglycerols, CDP-monoalkylglycerols, CDP-1Z-alkenylglycerols, glycosylglycerophospholipids, diacylglycosylglycerophospholipids, 1-alkyl,2-acylglycosylglycerophospholipids, 1Z-alkenyl,2-acylglycosylglycerophospholipids, dialkylglycosylglycerophospholipids, monoacylglycosylglycerophospholipids, monoalkylglycosylglycerophospholipids, 1Z-alkenylglycosylglycerophospholipids, glycerophosphoinositolglycans, diacylglycerophosphoinositolglycans, 1-alkyl,2-acylglycerophosphoinositolglycans, 1Z-alkenyl,2-acylglycerophosphoinositolglycans, monoacylglycerophosphoinositolglycans, monoalkylglycerophosphoinositolglycans, 1Z-alkenylglycerophosphoinositolglycans, glycerophosphonocholines, diacylglycerophosphonocholines, 1-alkyl,2-acylglycerophosphonocholines, 1Z-alkenyl,2-acylglycerophosphonocholines, dialkylglycerophosphonocholines, monoacylglycerophosphonocholines, monoalkylglycerophosphonocholines, 1Z-alkenylglycerophosphonocholines, glycerophosphonoethanolamines, diacylglycerophosphonoethanolamines, 1-alkyl,2-acylglycerophosphonoethanolamines, 1Z-alkenyl,2-acylglycerophosphonoethanolamines, dialkylglycerophosphonoethanolamines, monoacylglycerophosphonoethanolamines, monoalkylglycerophosphonoethanolamines, 1Z-alkenylglycerophosphonoethanolamines, di-glycerol tetraether phospholipids (caldarchaeols), glycerol-nonitol tetraether phospholipids, oxidized glycerophospholipids, oxidized glycerophosphocholines, and oxidized glycerophosphoethanolamines.

Sphingolipids may be characterized by a long-chain base (typically 12 to 26 carbon atoms) linked by an amide bond to a fatty acid and via a terminal hydroxyl group to complex carbohydrates or phosphorous functional groups. These lipids play important roles in signal transmission between cells and cell recognition. Example sphingolipids include sphing-4-enines (sphingosines), sphinganines, 4-hydroxysphinganines (phytosphingosines), sphingoid base homologs and variants, sphingoid base 1-phosphates, lysosphingomyelins and lysoglycosphingolipids, N-methylated sphingoid bases, sphingoid base analogs, ceramides, N-acylsphingosines (ceramides), N-acylsphinganines (dihydroceramides), N-acyl-4-hydroxysphinganines (phytoceramides), acylceramides, ceramide 1-phosphates, phosphosphingolipids, ceramide phosphocholines (sphingomyelins), ceramide phosphoethanolamines, ceramide phosphoinositols, phosphonosphingolipids, neutral glycosphingolipids, simple Glc series, GalNAcβ1-3Galα1-4Galβ1-4Glc- (globo series), GalNAcβ1-4Galβ1-4Glc- (ganglio series), Galβ1-3GlcNAcβ1-3Galβ1-4Glc- (lacto series), Galβ1-4GlcNAcβ1-3Galβ1-4Glc- (neolacto series), GalNAcβ1-3Galα1-3Galβ1-4Glc-(isoglobo series), GlcNAcβ1-2Manα1-3Manβ1-4Glc- (mollu series), GalNAcβ1-4GlcNAcβ1-3Manβ1-4Glc- (arthro series), acidic glycosphingolipids, gangliosides, sulfoglycosphingolipids (sulfatides), glucuronosphingolipids, phosphoglycosphingolipids, basic glycosphingolipids, amphoteric glycosphingolipids, and arsenosphingolipids.

Saccharolipids may be comprised of fatty acids linked directly to a sugar backbone. Typically, a monosaccharide takes the place of the glycerol molecule that forms the backbone of other lipids such as glycerolipids and glycerophospholipids. Saccharolipids play a role in the bilayer structure of cell membranes. Exemplary saccharolipids include acylaminosugars, monoacylaminosugars, diacylaminosugars, triacylaminosugars, tetraacylaminosugars, pentaacylaminosugars, hexaacylaminosugars, heptaacylaminosugars, acylaminosugar glycans, acyltrehaloses, and acyltrehalose glycans.

Glycoglycerolipids may be comprised of fatty acids linked through an ester oxygen to the first and second carbons of a glycerol molecule, with a carbohydrate functional group ester-linked to the third carbon atom. The carbohydrate functional group may include one or more sugar monomers. Other functional groups may also be linked to the carbohydrate functional group. Exemplary glycoglycerolipids include monogalactosyldiacylglycerols, digalactosyldiacylglycerols, trigalactosyldiacylglycerols, tetragalactosyldiacylglycerols, polygalactosyldiacylglycerols, monoglucosyldiacylglycerols, diglucosyldiacylglycerols, monogalactosylmonoacylglycerols, digalactosylmonoacylglycerols, sulfoquinovosyldiacylglycerols, acylsulfoquinovosyldiacylglycerols, acylgalactosylglucossyldiacylglycerols, kojibiosyldiaacylglycerols, galactofuranosyldiacylglycerols, galactopyranosyldiacylglycerols, 1,2-diacyl-3-O-a-D-glucuronyl-sn-glycerols, glucosylglucuronyldiacylglycerols, galacturonyldiacylglycerols, polyglucosyldiacylglycerols, and monoglucosyldiacylglycerols.

Sterol esters may be characterized as comprising alcohols sharing a fused four-ring steroid structure ester-linked to one or more fatty acyls. Examples include cholesteryl esters, campesterol esters, stigmasterol esters, sitosterol esters, avenasterol esters, fucosterol esters, isofucosterol esters, and ethylcholesteryl esters.

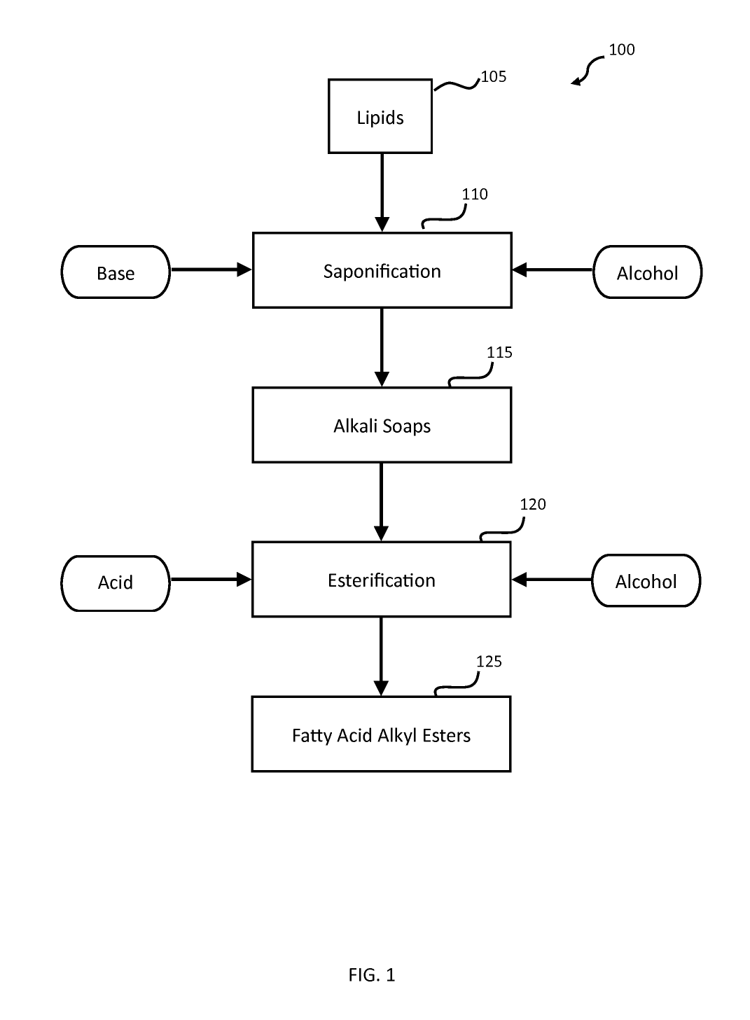

FIG. 1 illustrates a general flow chart of various embodiments of a method 100 for producing fatty esters from saponifiable lipids. At step 105, lipids are introduced into a reaction chamber. A saponification reaction occurs when a base is added to the reactor at step 110. One or more alcohols may be present during the saponification reaction (step 110) to aid in the formation of a homogeneous mixture of the lipids and the base. The product of the saponification reaction is one or more alkali soaps (step 115).

In general, saponification is the hydrolysis of esters under basic conditions. Using a triacylglycerol as an example (shown in Equation 1), in the presence of a base such as sodium hydroxide, the fatty acid groups are stripped from the glycerol backbone by hydrolysis to form fatty acid salts (alkali soaps) and glycerol as reaction products.

C₃H₅(COOR)₃+3NaOH→3RCOO⁻+3Na⁺+C₃H₅(OH)₃ Equation 1

If the saponification reaction described in the previous paragraph is performed in the presence of an alcohol and in the absence of water, and if a quantity of base sufficient to convert a portion of the alcohol to an alkoxide and to also act as a catalyst is present, any saponifiable lipids present may be transesterified directly to fatty esters. Using a triacylglycerol as an example (shown in Equation 2), in the presence of an alcohol and a base such as sodium hydroxide, the fatty acid carbonyl groups are subject to nucleophilic attack and subsequent replacement of the glycerol with the alcohol.

C₃H₅(COOR)₃+3R′OH+OH⁻→3RCOOR′+C₃H₅(OH)₃+OH⁻ Equation 2

The alkali soaps are then reacted with one or more alcohols in the presence of an acid in an esterification reaction at step 120. In various embodiments, the acid is a mineral acid. The acid neutralizes any residual base, converts alkali soaps into free fatty acids, and catalyzes the reaction. The acid may also serve as a dehydrating agent to sequester any water byproduct of the esterification reaction. The product of the esterification reaction is typically one or more fatty esters (step 125).

Esterification is simply the chemical process of producing esters. Most commonly, esters are formed from a fatty acid and an alcohol. In the example above, after neutralization, the carbonyl group of the alkali soap reacts with the alcohol according to Equation 3 to form one or more fatty esters (RCOOR′).

RCOO⁻+R′OH+2H⁺→RCOOH+R′OH+H⁺→RCOOR′+H⁺+H₂O Equation 3

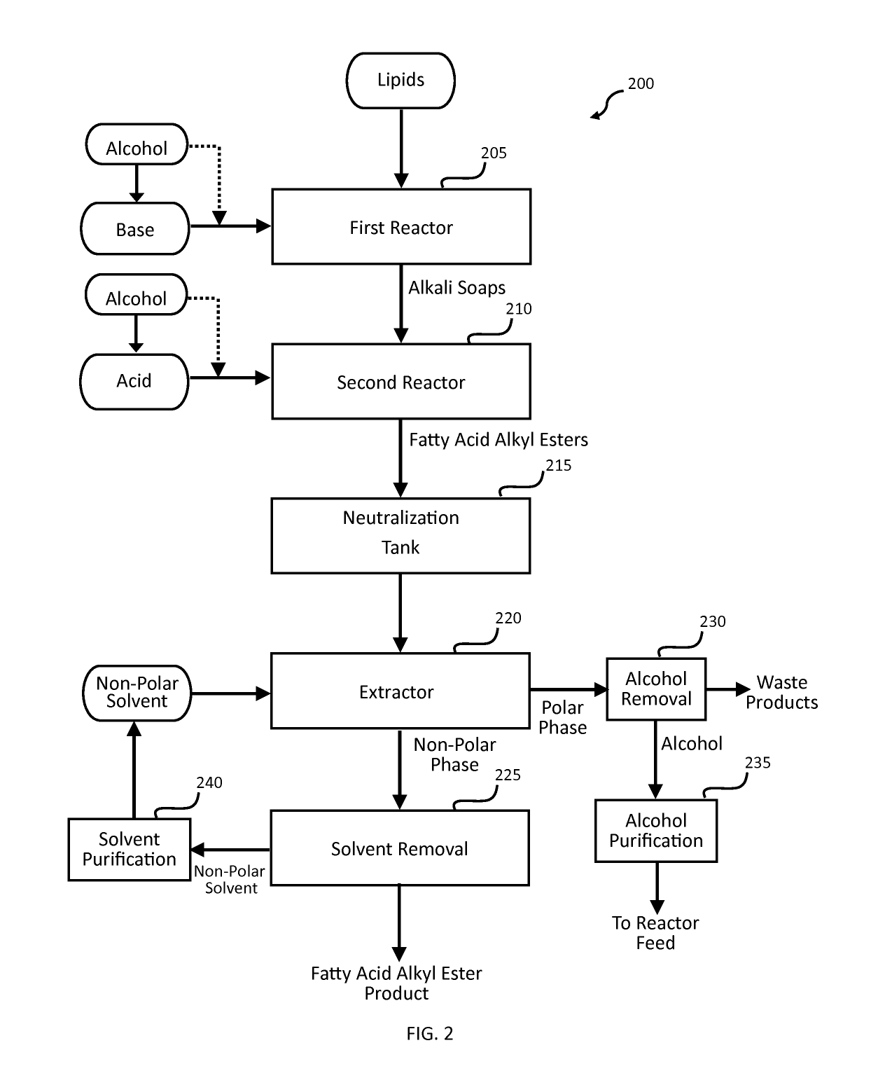

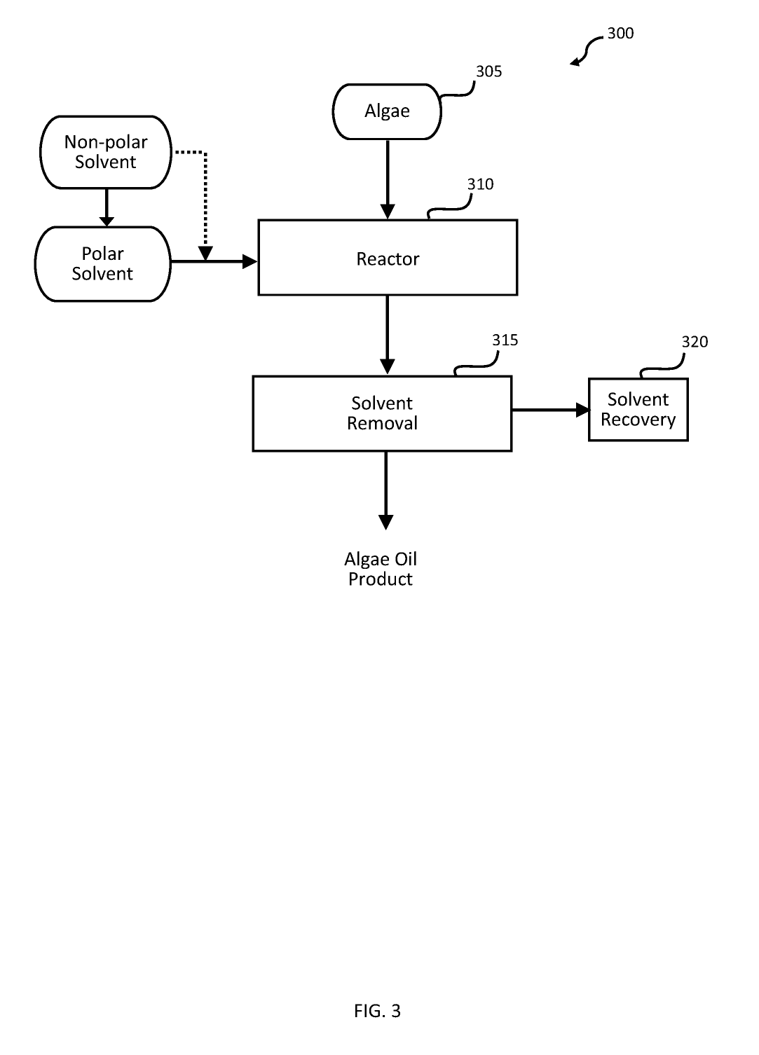

FIG. 2 illustrates an exemplary method 200 of producing fatty esters from saponifiable lipids. At step 205, saponifiable lipids are introduced into a reaction chamber. In various embodiments, the saponifiable lipids are the product of an extraction process involving various algae species (see FIG. 3). Algae are mostly aquatic photosynthetic organisms that range from microscopic flagellate to giant kelp. Algae may be loosely grouped into seven categories: Euglenophyta (euglenoids), Chrysophyta (golden-brown algae), Pyrrophyta (fire algae), Chlorophyta (green algae), Rhodophyta (red algae), Paeophyta (brown algae), and Xanthophyta (yellow-green algae). Lipid extracted from any algae species may be used in the various embodiments of the present invention, including Amphora, Anabaena, Anikstrodesmis, Botryococcus, Chaetoceros, Chlorella, Chlorococcum, Cyclotella, Cylindrotheca, Dunaliella, Emiliana, Euglena, Glossomastix, Hematococcus, Isochrysis, Monochrysis, Monoraphidium, Nannochloris, Nannochloropsis, Navicula, Nephrochloris, Nephroselmis, Nitzschila, Nodularia, Nostoc, Oochromonas, Oocystis, Oscillartoria, Pavlova, Phaeodactylum, Picochloris, Platymonas, Pleurochrysis, Porhyra, Pseudoanabaena, Pyramimonas, Scenedesmus, Stichococcus, Synechococcus, Synechocystis, Tetraselmis, Thalassiosira, and Trichodesmium.

Additionally, lipids from non-algae sources, such as plant oils and animal oils may also be used in various embodiments, as may various petroleum-based products and synthetic oils. Non-limiting examples of sources of non-algae lipids include fish oil, tung oil, colza oil, soy bean oil, corn oil, peanut oil, palm oil, rape seed oil, sunflower oil, safflower oil, corn oil, mineral oil, coconut oil, linseed oil, olive oil, sesame seed oil, animal fats, frying oil waste, sewage sludge, and the like.

One or more bases may be added to the reactor at step 205, which may initiate the saponification reaction discussed above. In various embodiments, one or more alcohols may be also be added at step 205. The base (or mixture of bases) may be any compound that is capable of supplying hydroxyl ions (OH⁻) to the reaction. Strong bases (compounds which dissociate completely) may tend to accelerate the rate of the saponification reaction and push the reaction more towards complete conversion of the lipids to alkali soaps. Non-limiting examples of strong bases are the hydroxides of alkali metals and alkaline earth metals, such as sodium hydroxide, potassium hydroxide, barium hydroxide, cesium hydroxide, strontium hydroxide, calcium hydroxide, lithium hydroxide, and rubidium hydroxide.

In some situations, various alkoxides (RO⁻) also form strong bases and may be used in various embodiments. If alkoxides are used, the amount of transesterification may increase relative to the amount of saponification, increasing the proportion of fatty esters produced in the base reaction. The most common alkoxides are sodium methoxide and potassium methoxide. Other alkoxides, for example those formed with the alkali metals and alkaline earth metals may also be used in various embodiments. Using an alkoxide as the base may have an added benefit of limiting the amount of water present in the reactor (see the discussion below of the effect of water). Alkoxides readily react with water, producing an alcohol and hydroxide ions. Therefore, commercially available alkoxides are generally water-free.

The base may be added to the reactor either before or after the lipids are introduced into the reactor. Alternatively, the base may be premixed with the lipids before the reactor. In various embodiments, the base may be premixed with the alcohol prior to adding the mixture to the reactor. By premixing the base and the alcohol, the mixture can be cooled prior to introduction into the reactor, thereby avoiding localized hot spots before the reactor contents thoroughly mix.

The alcohol may serve to aid the formation of a homogeneous mixture of the lipids and the base. The alcohol (or mixture of alcohols) may be selected for compatibility with the base. For example, if a methoxide is the base, then methanol may be selected as the alcohol because methoxide is the conjugate base of methanol. In various embodiments, a wide variety of other alcohols may be used, such as alcohols with the general formula CₙH₂ₙ₊₁OH. Examples of such alcohols include methanol, ethanol, propanol, butanol, etc. Alcohols in which one or more of the hydrogen atoms have been substituted with functional groups may also be suitable. Other embodiments may use other alcohols (having the general formula ROH), such as glycerol, various glycols, and other polyols. The R-group may be any alkyl or substituted alkyl group; primary, secondary, or tertiary; have an open-chain or cyclic structure; have carbon double bonds; halogen atoms; or an aromatic ring.

In various embodiments, the amount of the base required for the saponification reaction may be based, at least in part, on the amount and composition of the lipids. First, a stoichiometric amount of the base may be added to hydrolyze essentially all of the ester-linked lipids, including glycerolipids and other esters, to alkali soaps. Where the lipids are supplied from algae, the lipids may generally be fatty acyls (fatty acids), and the amount of the base should be sufficient to convert all of the fatty acyls to alkali soaps.

Second, in certain embodiments additional base may be added to function as a catalyst, promoting the formation of esters from alkali soaps and an alcohol. As shown in FIG. 1, first the ester-linked lipids are saponified using a strong base to alkali soaps, then the alkali soaps are esterified using an acid catalyst to fatty acid alkly esters. However, since strong bases also catalyze transesterification, if the saponification reaction is conducted in an alcohol solvent, some ester-linked lipids may be transesterified directly to fatty esters. Any fatty esters formed during the saponification reaction may simply flow through the esterification reaction and become part of the final product.

In various embodiments, the catalytic excess of the base added to the saponification reaction may range from about 0.1 percent to about 20 percent by weight of the total reactor contents (lipids, stoichiometric amount of the base, and the alcohol). Other ranges may also be suitable, such as from about 0.25 percent to about 5 percent by weight of the total reactor contents.

Returning to FIG. 2, the alkali soap product of the saponification reaction may be transported to a second reactor at step 210 for the esterification reaction. One or more acids may then be added to the reactor at step 210, which initiates the esterification reaction discussed above. One or more alcohols may also be added at step 210. In various embodiments, the acid may be a mineral acid. The mineral acid (or mixture of mineral acids) may be any compound that is capable of supplying hydrogen ions (H⁺) to the reaction. Strong acids (compounds which completely dissociate into hydrogen ions and anions) may tend to accelerate the rate of the esterification reaction and push the reaction more towards complete conversion of the alkali soaps to fatty esters. Non-limiting examples of strong acids are sulfuric acid, hydrochloric acid, nitric acid, perchloric acid, hydrobromic acid, boron trifluoride, and hydroiodic acid.

Similar to the base added at step 205, the acid may be added to the reactor either before or after the alkali soaps are introduced into the reactor. In various embodiments, the acid may be premixed with the alcohol prior to adding the mixture to the reactor. By premixing the acid and the alcohol, the mixture can be cooled prior to introduction into the reactor, thereby avoiding localized hot spots before the reactor contents thoroughly mix.

The amount of acid added to the reactor at step 210 may depend on at least three factors. First, the acid may neutralize any excess, unreacted base from the saponification reaction. Once the excess base is neutralized, a stoichiometric amount of the acid may be added to convert the alkali soaps to fatty acids. Finally, the acid may be added as a catalyst.

One or more alcohols may also be added at step 210. The alcohols discussed above for the saponification reaction may also be suitable for the esterification reaction. In various embodiments, the alcohols used in the saponification reaction are the same as the alcohols used in the esterification reaction. In other embodiments, the alcohols used for the two reactions may be different.

Following the esterification reaction, the reaction mixture may be acidic in nature, and removing the acidity may be beneficial for further processing. For example, the selection of materials of construction for pipes, tanks, pumps, etc. may be simplified if acidic conditions are not a consideration. Therefore, the fatty acid alkyl esters and other contents of the second reactor may be moved to a neutralization tank at step 215 after the esterification reaction. In various embodiments, the neutralization step is optional. At the neutralization tank, a base may be added to bring the pH of the tank contents to a neutral level. In various embodiments, the pH may be raised to within a range from about 5 to about 9. For process convenience and to avoid undesired side reactions, the base selected for the neutralization step may be the same base used in the saponification reaction. However, a different base may be used in various embodiments.

Following neutralization (or following the esterification reaction if there is no neutralization step), the fatty esters may be separated from the reaction mixture to form a more concentrated fatty ester product. This separation may occur in a liquid extraction system at step 220. A solvent may be added to the reaction mixture, which in some embodiments is a non-polar solvent. Non-polar solvents have insignificant electromagnetic activity, and are commonly classified as having a dielectric constant less than 15. Examples of non-polar solvents include hexane, cyclohexane, heptane, d-limonene, naphtha, xylene, toluene, pentane, cyclopentane, benzene, 1,4-dioxane, chloroform, diethyl ether, dichloromethane, tetrahydrofuran, methyl acetate, mixed methyl esters such as biodiesel, and ethyl esters such as ethyl acetate.

The addition of the non-polar solvent may cause the reaction mixture to separate into a polar phase and a non-polar phase. The fatty acid alkyl esters, being generally non-polar compounds, tend to migrate to the non-polar phase along with the non-polar solvent. A variety of methods, such as centrifugation, cyclone separation, bypass filtering, decanting, settling, and the like may be used either individually or in combination to affect the separation of the phases. A multi-stage liquid extractor, such as a staged mixer-settler or a counter-current extraction column, may also be used. After the two phases are separated, the non-polar phase may undergo further processing through a solvent removal operation at step 225. After solvent removal, a more concentrated fatty ester product may be produced. In various embodiments, the solvent recovered at the solvent removal operation (step 225) may be recycled for reuse in the extraction process (step 220). The recovered solvent may undergo one or more further purification operations (step 240) prior to reuse.

The polar phase recovered from the extractor (step 220) may contain any remaining alcohols from the saponification and esterification reactions. Similar to the extraction solvent, the recovered alcohols may be reused in the process and may require removal from other waste products (step 230) and further purification (step 235) prior to reuse.

The first and second reactor may be any suitable reactor known in the art. Example reactors are batch reactors, fixed-bed plug flow reactors, continuous stirred tank reactors, and the like. The reactor may be a section of pipe. In various embodiments, the reactor may be agitated by mechanical devices or non-mechanical processes such as ultrasonics. Reactors with static mixing such as reactors containing contact structures such as baffles, trays, packing, and other impingement structures may also be used. Each of the first and second reactors may be comprised of multiple reactors operated either in series or parallel. In various embodiments employing batch processing, one or more of the steps illustrated in FIG. 2 may occur in a single vessel. For example, the first and second reactor and the neutralization tank may all be the same vessel.

The saponification reaction and the esterification reaction may occur at ambient temperature or at elevated temperature. Elevated temperatures may tend to decrease reaction times. In various embodiments, the saponification reaction and the esterification reaction temperature may be maintained in the range from about 30° C. to about 200° C., or in the range from about 30° C. to about 140° C. Likewise, the neutralization (step 215), extraction (step 220), and solvent removal (step 225) may be carried out at elevated temperatures.

The pressure of each of the steps of FIG. 2 in various embodiments may be carried out at about atmospheric pressure, although some embodiments may be carried out at higher or lower pressures.

As stated above, the saponifiable lipids may be obtained from an extraction process involving various algae species. FIG. 3 illustrates an exemplary method 300 of extracting algae oil containing saponifiable lipids from algae according to various embodiments of the present invention. At step 305, algae is obtained from any source commonly known in the art. For example, the algae may be provided in dry form in which a portion of the moisture has been removed from the cells, or wet form in which the algae cells are suspended in a liquid, typically water. In either the wet or dry form, the algae cell walls may be intact, or the cell walls may be fractured. Dry algae may be powdered or pelletized, or any other form known in the art.

For the purpose of lipid extraction, healthy algae may be used. The lipid content of healthy algae is known to have a low triglyceride content, such that a large portion of the lipids exists as phospholipids or other polar lipids. The polar lipids have limited solubility in solvents typically used to extract lipids from algae. It has been found that a mixture of at least one non-polar solvent and at least one polar solvent under proper conditions will yield significantly higher lipid extraction yields than commonly used solvents alone.

Returning to FIG. 3, the algae may then be introduced into a reactor (step 310). One or more solvents may then be added to the reactor. The solvent (or mixture of solvents) may include one or more non-polar solvents and may include one or more polar solvents. The non-polar solvents may have a dielectric constant less than about 5 and a molecular weight greater than about 70. The polar solvents may have a dielectric constant greater than about 15 and a molecular weight less than about 90, and may be protic or aprotic. Non-limiting examples of non-polar solvents include benzene, chloroform, cyclohexane, cyclopentane, 1,4-dioxane, hexane, pentane, and toluene. Non-limiting examples of polar solvents include acetone, acetonitrile, n-butanol, dimethylformamide, dimethylsulfoxide, ethanol, formic acid, isopropanol, methanol, and n-propanol.

In various embodiments using a mixture of at least one non-polar solvent and at least one polar solvent, the weight percent of the polar solvent may range from about 0.1 percent to about 30 percent. The remainder of the mixture may be composed essentially of the one or more non-polar solvents. For example, the solvent mixture may be comprised of about 10 percent by weight methanol (dielectric constant=33, molecular weight=32.0) and about 90 percent by weight hexane (dielectric constant=2.0, molecular weight=86.2).

Typically, polar and non-polar solvents are immiscible at ambient temperatures. In various embodiments of the present invention, the reactor contents (algae and one or more solvents) may be heated to a temperature less than the boiling point of the one or more solvents at which there is a non-ionic dissolution of either the non-polar or polar solvent, and the solvents form a single phase. In various embodiments, the temperature of the reactor contents may range from about 30° C. to about 100° C.

The pressure of the reactor at step 310 in various embodiments may be about atmospheric pressure, although some embodiments may be at higher or lower pressures.

The reactor may be any suitable reactor known in the art. Exemplary reactors are batch reactors, fixed-bed plug flow reactors, continuous stirred tank reactors, soxhlet extractors, continuous counter-current extractors, and the like. The reactor may be a section of pipe. In various embodiments, the reactor may be agitated by mechanical devices or non-mechanical processes such as ultrasonics. Reactors with static mixing such as reactors containing contact structures such as baffles, trays, packing, and other impingement structures may also be used. The reactor may be comprised of multiple reactors operated either in series or parallel. In various embodiments employing batch processing, one or more of the steps illustrated in FIG. 3 may occur in a single vessel. For example, the reactor step and the solvent removal step may occur in the same vessel.

In various embodiments, the solvents and algae remain in contact for a period of time ranging from about 0.5 minute to about 24 hours, although the contact time may be longer for some embodiments. The solvent is then removed at step 315. A filtration step (not shown) may precede solvent removal to separate the majority of the solvent from the remaining solid algae or algae particles. In various embodiments, the solvent may be evaporated, leaving the algae oil (saponified lipids) product. In various embodiments, the solvent recovered at the solvent removal operation (step 315) may be recycled for reuse in the reactor (step 310). The recovered solvent may undergo one or more purification operations prior to reuse.

An exemplary computing system may be used to implement various embodiments of the systems and methods disclosed herein. The computing system may include one or more processors and memory. Main memory stores, in part, instructions and data for execution by a processor to cause the computing system to control the operation of the various elements in the systems described herein to provide the functionality of certain embodiments. Main memory may include a number of memories including a main random access memory (RAM) for storage of instructions and data during program execution and a read only memory (ROM) in which fixed instructions are stored. Main memory may store executable code when in operation. The system further may include a mass storage device, portable storage medium drive(s), output devices, user input devices, a graphics display, and peripheral devices. The components may be connected via a single bus. Alternatively, the components may be connected via multiple buses. The components may be connected through one or more data transport means. Processor unit and main memory may be connected via a local microprocessor bus, and the mass storage device, peripheral device(s), portable storage device, and display system may be connected via one or more input/output (I/O) buses. Mass storage device, which may be implemented with a magnetic disk drive or an optical disk drive, may be a non-volatile storage device for storing data and instructions for use by the processor unit. Mass storage device may store the system software for implementing various embodiments of the disclosed systems and methods for purposes of loading that software into the main memory. Portable storage devices may operate in conjunction with a portable non-volatile storage medium, such as a floppy disk, compact disk or Digital video disc, to input and output data and code to and from the computing system. The system software for implementing various embodiments of the systems and methods disclosed herein may be stored on such a portable medium and input to the computing system via the portable storage device. Input devices may provide a portion of a user interface. Input devices may include an alpha-numeric keypad, such as a keyboard, for inputting alpha-numeric and other information, or a pointing device, such as a mouse, a trackball, stylus, or cursor direction keys. In general, the term input device is intended to include all possible types of devices and ways to input information into the computing system. Additionally, the system may include output devices. Suitable output devices include speakers, printers, network interfaces, and monitors. Display system may include a liquid crystal display (LCD) or other suitable display device.

Display system may receive textual and graphical information, and processes the information for output to the display device. In general, use of the term output device is intended to include all possible types of devices and ways to output information from the computing system to the user or to another machine or computing system. Peripherals may include any type of computer support device to add additional functionality to the computing system. Peripheral device(s) may include a modem or a router or other type of component to provide an interface to a communication network. The communication network may comprise many interconnected computing systems and communication links. The communication links may be wireline links, optical links, wireless links, or any other mechanisms for communication of information. The components contained in the computing system may be those typically found in computing systems that may be suitable for use with embodiments of the systems and methods disclosed herein and are intended to represent a broad category of such computing components that are well known in the art. Thus, the computing system may be a personal computer, hand held computing device, telephone, mobile computing device, workstation, server, minicomputer, mainframe computer, or any other computing device. The computer may also include different bus configurations, networked platforms, multi-processor platforms, etc.

Various operating systems may be used including Unix, Linux, Windows, Macintosh OS, Palm OS, MS-DOS, MINIX, VMS, OS/2, and other suitable operating systems. Due to the ever changing nature of computers and networks, the description of the computing system is intended only as a specific example for purposes of describing embodiments. Many other configurations of the computing system are possible having more or less components.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

While the present invention has been described in connection with a series of preferred embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

### Example 1

Approximately 15 liters of hexane were added to 9406.9 grams of pelletized algae. The algae contained about 8.2 percent saponifiable lipids for a total of about 768 grams of saponifiable lipids. The pellets were soaked for 17 hours at 50° C. to extract crude algal oil. The liquid hexane-oil mixture was drained and the hexane was evaporated off under vacuum. This resulted in 926.3 grams of crude algal oil.

The hexane was returned to the pellets and the pellets were soaked a second time for 17 hours at 50° C. to extract an additional amount of residual crude algal oil from the pellets. The liquid hexane-oil mixture was drained and the hexane was evaporated off under vacuum, resulting in an additional 198.7 grams of crude algal oil.

The hexane was returned to the pellets and they soaked a third time for 17 hours at 50° C. The liquid hexane-oil mixture was drained and the hexane was evaporated off under vacuum, resulting in an additional 68.0 grams of crude algal oil.

The total crude algal oil from these three extractions was 1,193 grams. The crude algal oil contained about 33.4 percent saponifiable lipids. The extraction efficiency for these three cycles with hexane was about 52 percent.

### Example 2

Approximately 7.8 liters of hexane and 200 milliliters of methanol were added to 4,266.9 grams of pelletized algae. The algae contained about 15.9 percent saponifiable lipids for a total of about 678.5 grams of saponifiable lipids. The pellets were soaked for 17 hours at 50° C. to extract crude algal oil. The liquid hexane-methanol-oil mixture was drained and the hexane and methanol were evaporated off under vacuum. This resulted in 430.3 grams of crude algal oil.

The hexane-methanol mixture was returned to the pellets and the pellets were soaked a second time for 17 hours at 50° C. to extract an additional amount of residual crude algal oil from the pellets. The liquid hexane-methanol-oil mixture was drained and the hexane and methanol were evaporated off under vacuum, resulting in an additional 305.1 grams of crude algal oil.

The hexane-methanol mixture was returned to the pellets a third time with some additional hexane to cover the pellets, and they soaked for 17 hours at 50° C. The liquid hexane-methanol-oil mixture was drained and the hexane and methanol were evaporated off under vacuum, resulting in an additional 112.1 grams of crude algal oil.

The total crude algal oil from these three extractions was 847.5 grams. The crude algal oil contained about 50 percent saponifiable lipids. The extraction efficiency for these three cycles with 2.5% methanol (volumetric) in hexane was about 62 percent.

### Example 3

Approximately 7.6 liters of hexane and 400 mililiters of methanol were added to 4,301.1 grams of pelletized algae. The algae contained about 9.9 percent saponifiable lipids for a total of 426 grams of saponifiable lipids. The pellets were soaked for 17 hours at 50° C. to extract crude algal oil. The liquid hexane-methanol-oil mixture was drained and the hexane and methanol were evaporated off under vacuum. This resulted in 516.2 grams of crude algal oil.

The hexane-methanol mixture was returned to the pellets and the pellets were soaked a second time for 17 hours at 50° C. to extract an additional amount of residual crude algal oil from the pellets. The liquid hexane-methanol-oil mixture was drained and the hexane and methanol were evaporated off under vacuum, resulting in an additional 182.9 grams of crude algal oil.

The hexane-methanol mixture was returned to the pellets with some additional hexane to cover the pellets, and they soaked a third time for 17 hours at 50° C. The liquid hexane-methanol-oil mixture was drained and the hexane and methanol were evaporated off under vacuum, resulting in an additional 52.9 grams of crude algal oil.

The total crude algal oil from these three extractions was 752 grams. This crude algal oil contained about 37.2 percent saponifiable lipids. The extraction efficiency for these three cycles with 5 percent methanol (volumetric) in hexane was about 66 percent.

### Example 4

Approximately 7.2 liters of hexane and 800 milliliters of methanol were added to 4,301.7 grams of pelletized algae. The algae contained about 9.9 percent saponifiable lipids for a total of about 426 grams saponifiable lipids. The pellets were soaked for 17 hours at 50° C. to extract crude algal oil. The liquid hexane-methanol-oil mixture was drained and the hexane and methanol were evaporated off under vacuum. This resulted in 507.9 grams of crude algal oil.

The hexane-methanol mixture was returned to the pellets and the pellets were soaked a second time for 17 hours at 50° C. to extract an additional amount of residual crude algal oil from the pellets. The liquid hexane-methanol-oil mixture was drained and the hexane and methanol were evaporated off under vacuum, resulting in an additional 227.8 grams of crude algal oil.

The hexane-methanol mixture was returned to the pellets with some additional hexane to cover the pellets, and they soaked a third time for 17 hours at 50° C. The liquid hexane-methanol-oil mixture was drained and the hexane and methanol were evaporated off under vacuum, resulting in an additional 74.0 grams of crude algal oil.

The total crude algal oil from these three extractions was 809.7 grams. This crude oil contained 37.5 percent saponifiable lipids. The extraction efficiency for these three cycles with 10 percent methanol (volumetric) in hexane was about 71 percent.

### Example 5

Approximately 6.8 liters of hexane and 1.2 liters of methanol were added to 4,391.7 grams of pelletized algae. The algae contained about 12.1 percent saponifiable lipids for a total of 531.4 grams saponifiable lipids. The pellets were soaked for 17 hours at 50° C. to extract crude algal oil. The liquid hexane-methanol-oil mixture was drained and the hexane and methanol were evaporated off under vacuum. This resulted in 679.7 grams of crude algal oil.

The hexane-methanol mixture was returned to the pellets and the pellets were soaked a second time for 17 hours at 50° C. to extract an additional amount of residual crude algal oil from the pellets. The liquid hexane-methanol-oil mixture was drained and the hexane and methanol were evaporated off under vacuum, resulting in an additional 288.9 grams of crude algal oil.

The hexane-methanol mixture was returned to the pellets with some additional hexane to cover the pellets, and they soaked a third time for 17 hours at 50° C. The liquid hexane-methanol-oil mixture was drained and the hexane and methanol were evaporated off under vacuum, resulting in an additional 89.3 grams of crude algal oil.

The total crude oil from these three extractions was 1,057.9 grams. This crude oil contained 43.5 percent saponifiable lipids. The extraction efficiency for these three cycles with 15 percent methanol (volumetric) in hexane was about 87 percent.

What is claimed is:

1. A method for extracting lipids from algae, the method comprising:
contacting algae with at least one non-polar solvent and with at least one polar solvent to form a mixture;
heating the mixture to a temperature for a predetermined period of time to extract at least a portion of lipids from the algae into the at least one non-polar solvent and the at least one polar solvent.

2. The method of claim 1, wherein the at least one non-polar solvent has a dielectric constant less than or equal to about 5 and the at least one polar solvent has a dielectric constant greater than or equal to about 15.

3. The method of claim 1, wherein the temperature causes a non-ionic dissolution of either the non-polar solvent or the polar solvent, and the two solvents form a single phase.

4. The method of claim 1, wherein the temperature is a temperature at which the non-polar solvent and the polar solvent are miscible.

5. The method of claim 1, wherein the temperature is less than a boiling point of the at least one non-polar solvent or the one polar solvent.

6. The method of claim 1, wherein the temperature ranges from about 30° C. to about 100° C.

7. The method of claim 1, wherein the temperature causes a non-ionic dissolution of the two solvents to form a single phase.

8. The method of claim 1, wherein the at least one non-polar solvent and the at least one polar solvent comprise about 0.1 percent by weight to about 30 percent by weight of the at least one polar solvent, with a balance predominantly the at least one non-polar solvent.

9. The method of claim 1, wherein the at least one non-polar solvent has an acyclic structure with one to ten carbon atoms.

10. The method of claim 1, wherein the at least one polar solvent has an acyclic structure with one to ten carbon atoms.

11. The method of claim 1, wherein the at least one non-polar solvent is hexane.

12. The method of claim 1, wherein the at least one polar solvent is methanol.

13. The method of claim 1, wherein the at least one polar solvent is about 0.1 percent by weight to about 30 percent by weight methanol and the non-polar solvent is in hexane.

14. The method of claim 1, wherein the predetermined period of time ranges from about 0.5 minute to about 24 hours.

15. The method of claim 1, wherein at least a portion of the algae is comprised of one or more of algae species Amphora, Anabaena, Anikstrodesmis, Botryococcus, Chaetoceros, Chlorella, Chlorococcum, Cyclotella, Cylindrotheca, Dunaliella, Emiliana, Euglena, Glossomastix, Hematococcus, Isochrysis, Monochrysis, Monoraphidium, Nannochloris, Nannochloropsis, Navicula, Nephrochloris, Nephroselmis, Nitzschila, Nodularia, Nostoc, Oochromonas, Oocystis, Oscillartoria, Pavlova, Phaeodactylum, Picochloris, Platymonas, Pleurochrysis, Porhyra, Pseudoanabaena, Pyramimonas, Scenedesmus, Stichococcus, Synechococcus, Synechocystis, Tetraselmis, Thalassiosira, or Trichodesmium.

16. The method of claim 1, wherein the molecular weight of the non-polar solvent is greater than or equal to about 70.

17. The method of claim 1, wherein the molecular weight of the polar solvent is less than or equal to about 90.

18. The method of claim 1, wherein the non-polar solvent is selected from the group consisting of benzene, chloroform, cyclohexane, cyclopentane, 1,4-dioxane, hexane, pentane, toluene, and mixtures thereof.

19. The method of claim 1, wherein the polar solvent is selected from the group consisting of acetone, acetonitrile, n-butanol, dimethylformamide, dimethylsulfoxide, ethanol, formic acid, isopropanol, methanol, n-propanol, and mixtures thereof.

20. The method of claim 1, the method further comprising separating the portion of lipids from the at least one non-polar solvent and the at least one polar solvent.

21. The method of claim 1, wherein the algae is substantially dry before the contacting step.

22. A method for extracting lipids from algae, the method comprising:
contacting substantially dry algae of species Nannochloropsis with hexane and methanol to form a mixture;
heating the mixture to a temperature ranging from about 30° C. to about 100° C. for at least 1 minute to extract at least a portion of lipids from the algae into the hexane and methanol; and
separating the portion of lipids from the hexane and methanol.

23. A method for extracting lipids from algae, the method comprising:
forming a mixture of at least one non-polar solvent and at least one polar solvent;
contacting the mixture with algae for a predetermined period of time at a predetermined temperature to extract at least a portion of lipids from the algae into the at least one non-polar solvent and the at least one polar solvent.
